(19) United States
(12) Patent Application Publication
(10) Pub. No.: US 2024/0086444 A1
(43) Pub. Date: Mar. 14, 2024

(54) Systems and Methods for Generating Knowledge Graphs and Text Summaries from Document Databases

(71) Applicant: The Board of Trustees of the Leland Stanford Junior University, Stanford, CA (US)

(72) Inventor: Stefano Emanuele Rensi, Stanford, CA (US)

(73) Assignee: The Board of Trustees of the Leland Stanford Junior University, Stanford, CA (US)

(21) Appl. No.: 17/754,724

(22) PCT Filed: Oct. 9, 2020
(86) PCT No.: PCT/US2020/055148

§ 371 Date: Apr. 8, 2022

Related U.S. Application Data
(60) Provisional application No. 62/914,372, filed on Oct. 11, 2019.
(60) Provisional application No. 62/981,468, filed on Feb. 25, 2020.

(51) Int. Cl. G06F 16/34; G06F 16/36

(52) U.S. Cl. CPC G06F 16/345; G06F 16/367

(57) ABSTRACT

Systems and methods for generating knowledge graphs and text summaries from document databases are provided. In one embodiment, a system for generating knowledge graphs and text summaries includes: a device, including: a processor; and a memory containing a knowledge graph and text summary generating application, where the knowledge graph and text summary generating application directs the processor to: query a global network of biomedical relationships; construct a knowledge graph and a citation graph; apply processes to learn local context-based weights and compute summarizations; and provide results via a display.

### CROSS-REFRENCE TO RELATED APPLICATIONS

The current application claims priority to U.S. Provisional Patent Application No. 62/914,372, entitled “Docs2Graph” and filed Oct. 11, 2019, and to U.S. Provisional Patent Application No. 62/981,468, entitled “Local Network Representations of Databases” and filed Feb. 25, 2020. The disclosures of U.S. Provisional Patent Application Nos. 62/914,372 and 62/981,468 are incorporated by reference herein in their entirety.

### STATEMENT OF FEDERALLY SPONSORED RESEARCH

This invention was made with government support under contract TR002515 awarded by the National Institutes of Health. The Government has certain rights in the invention.

### FIELD OF THE INVENTION

The invention is generally directed to knowledge graphs, and more specifically to systems and methods for generating biomedical knowledge graphs.

### BACKGROUND

Knowledge graphs (KGs) can be a powerful method of modeling general abstract knowledge, and can be used in many biomedical informatics, data science, and artificial intelligence applications. KGs can come from manual curation or from automatic creation, and the quality of the KG can be critical for downstream applications. Context can be a key feature that must be captured for the best uses of knowledge graphs. Global KGs built on natural language processing (NLP) annotated literature may have high sensitivity for important relationships but poor specificity because context could have been lost. Ideally, KGs would operate such that they can be locally consistent, where context can be either implicit or explicit but can be shared.

Biomedical ontologies can model the languages of clinical medicine, molecular biology and chemistry. Chemical structures, protein signaling pathways, cellular processes, and phylogenies can commonly be represented using graph diagrams. Semantic web technology and graph query languages can be used to index, connect, and query information across datasets and domains. The combination of these elements with analysis, visualization, and machine learning can yield insights and power artificial intelligence (AI) applications.

### SUMMARY OF THE INVENTION

Systems and methods in accordance with many embodiments of the invention implement generating knowledge graphs and text summaries from document databases. In one embodiment, a device for generating knowledge graphs and text summaries, includes: a processor; and a memory containing a knowledge graph and text summary generating application, where the knowledge graph and text summary generating application directs the processor to: query a global network of biomedical relationships; construct a knowledge graph and a citation graph; apply processes to learn local context-based weights and compute summarizations; and provide results via a display.

In a further embodiment, the knowledge graph and text summary generating application directs the processor to provide results via a user interface.

In still a further embodiment, the user interface includes controls.

In a yet further embodiment, the controls include a scale.

In a yet further embodiment again, the controls include types of search.

In another embodiment again, the device queries pubmed

In a further additional embodiment, a system for generating knowledge graphs and text summaries includes: a device, including: a processor; and a memory containing a knowledge graph and text summary generating application, where the knowledge graph and text summary generating application directs the processor to: query a global network of biomedical relationships; construct a knowledge graph and a citation graph; apply processes to learn local context-based weights and compute summarizations; and provide results via a display.

In a further additional embodiment, the device is configured to interpret results of a chemical screen.

In still a further additional embodiment, the device is configured to interpret results of genetic experiments.

In a still yet further embodiment, the device is configured to characterize a knowledge space of a subject matter expert.

In still a further additional embodiment, a method of generating knowledge graphs and text summaries includes: querying a global network of biomedical relationships; constructing a knowledge graph and a citation graph; applying processes to learn local context-based weights and computing summarizations; and providing results via a display.

In a further additional embodiment, providing results via a display includes displaying the results via a user interface.

### BRIEF DESCRIPTION OF THE DRAWINGS

The description and claims will be more fully understood with reference to the following figures, which are presented as exemplary embodiments of the invention and should not be construed as a complete recitation of the scope of the invention.

FIG. 1 illustrates a knowledge graph and text summaries generating system in accordance with an embodiment of the invention.

FIG. 2 illustrates a knowledge graph and text summaries generating device in accordance with an embodiment of the invention.

FIG. 3 is a flow chart illustrating a process for generating knowledge graph and text summaries in accordance with an embodiment of the invention.

FIGS. 4A-4B illustrate an application using a model, a view, and a controller architecture in accordance with an embodiment of the invention.

FIG. 5 illustrates an underlying property graph data model and instantiation in accordance with an embodiment of the invention.

FIG. 6 illustrates an architecture implemented as a bundle of independent micro services in accordance with an embodiment of the invention.

FIG. 7 illustrates a user interface having control modules and display modules in accordance with an embodiment of the invention.

### DETAILED DESCRIPTION

Turning now to the drawings, systems and methods for generating knowledge graphs and text summaries from document databases in accordance with various embodiments of the invention are illustrated. In many embodiments, systems and methods described herein can synthesize, organize, and summarize sets of documents to facilitate exploration, understanding, and curation. In numerous embodiments, systems and methods for generating knowledge graphs and text summaries from document databases can be used for augmentation of reading comprehension. In several embodiments, systems and methods for generating knowledge graphs and text summaries from document databases can be used for Interpreting the results of chemical screens (e.g. computational or experimental), interpreting the results of genetic experiments (e.g. computational or experimental), and/or interpreting or explaining the output of machine learning models (e.g. biclustering, or neural network). In certain embodiments, systems and methods for generating knowledge graphs and text summaries from document databases can be used for characterizing the knowledge space of a subject matter expert, augmenting the knowledge space of a subject matter expert (i.e. personalized curation), and/or simulating the “Deplhi method”, i.e. computing knowledge graphs for subject matter experts (SMEs) in isolation and computing a combined knowledge graph using the union.

In several embodiments, systems and methods described herein can be employed to present information in a large knowledge graph (KG) to a user in an intelligible way. In many embodiments, systems and methods described herein can prioritize nodes (concepts) by giving weight to nodes. In many embodiments page rank can be used, which can be done with any of a multitude of node weight learning methods. In certain embodiments, systems and methods described herein can prioritize edges (relationships), can learn node embeddings and use similarities, and can also include features like the number of supporting sentences or documents. The rank or weights of supporting documents can be performed according to a ranking or weighting method (i.e. page rank without links).

In some embodiments, using local knowledge graphs can speed up the process of learning embeddings. Note that the scoring and ranking of documents and sentences can be a key part of summarization. There can be many criteria that can be used to rank sentences. It many include features derived from document metadata, predicate weights from the KG, prediction scores from an NLP annotation software, content of the text (i.e. presence of key words or concepts), length of the sentence, perplexity of the sentence, and/or syntactic features (i.e. sentence structure). In certain embodiments, systems and methods described herein can perform text summarization, by generating an intelligible and coherent text summary. In several embodiments, systems and methods described herein can include transformation of the summary KG into a sentence graph where each node is a sentence, and each edge is a concept shared by two sentences. Note that this is not something that is typically done with either KGs or in “normal” text summarization methods like LexRank (LexRank is an unsupervised approach to text summarization based on graph-based centrality scoring of sentences), which generally do not use the summarization of a large KG to generate sentence graphs. In many embodiments, a depth first search can ensure a coherent ordering of sentences, though other graph types of graph traversals and orderings can be used.

In several embodiments, systems and methods for generating knowledge graphs and text summaries from document databases can include docs2graph (D2G), which is a method/application for generating local knowledge graphs from subnetworks of global network of biomedical relationships (GNBR) that can increase specificity with minimal loss of sensitivity. This method can exploit an adjunction between knowledge graphs and citation graphs. In some embodiments, docs2graph can implement summarization methods that can generate adjoint (a) visual (abstractive) and (b) text (extractive) summaries.

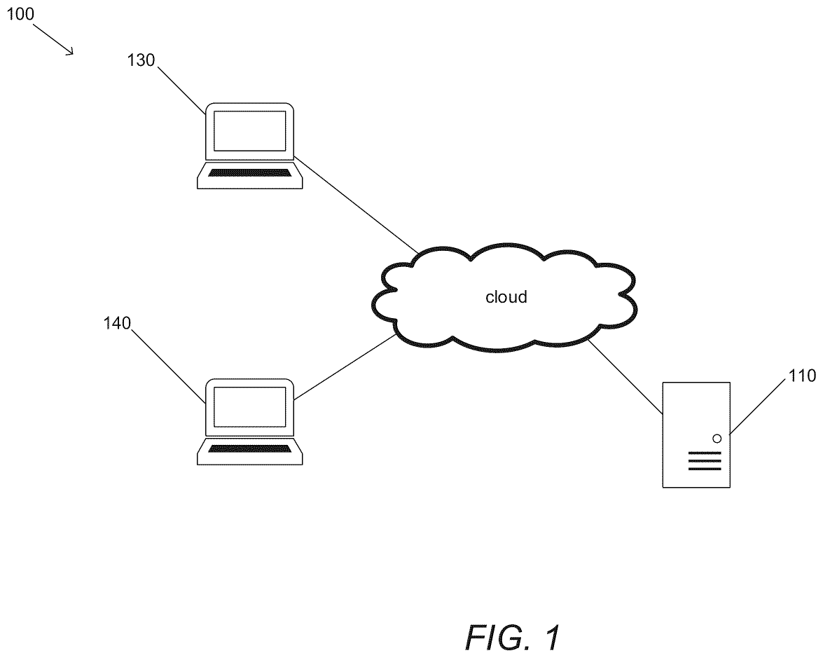

Turning now to FIG. 1, a system for generating knowledge graphs and text summaries from document databases in accordance with an embodiment of the invention is illustrated. System 100 can include a device 110 for generating knowledge graphs and text summaries from document databases. System 100 can also include a training device 120. In numerous embodiments, training devices can be computing systems that can train neural networks. System 100 can further include computing devices 130 and 140, which can be used to display images. While specific systems and methods for generating knowledge graphs and text summaries from document databases are described above, any of a variety of different configurations of systems and methods for generating knowledge graphs and text summaries from document databases can be utilized as appropriate to the requirements of specific applications in accordance with various embodiments of the invention. An implementation of a device for generating knowledge graphs and text summaries from document databases is discussed below.

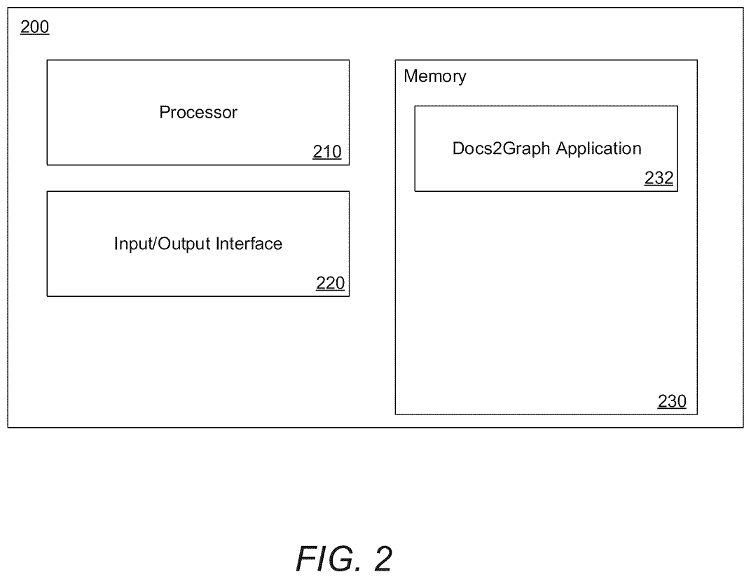

Turning now to FIG. 2, a device for generating knowledge graphs and text summaries from document databases in accordance with an embodiment of the invention is illustrated. Device 200 can include a processor 210. Processors can be any type of logic processing unit, including, but not limited to, central processing units (CPUs), graphics processing units (GPUs), Application Specific Integrated Circuits (ASICs), Field-Programmable Gate-Arrays (FPGAs), and/or any other processing circuitry as appropriate to the requirements of specific applications of embodiments of the invention. Device 200 can further include an input/output (I/O) interface 220. I/O interfaces can enable connections with external networks and/or devices as required. In numerous embodiments, the I/O interface connects to a display. In a variety of embodiments, the display can be an external device. Device 200 can further include a memory 230. Memory can be any type of computer readable medium, including, but not limited to, volatile memory, non-volatile memory, a mixture thereof, and/or any other memory type as appropriate to the requirements of specific applications of embodiments of the invention. Memory 230 can contain an application for generating knowledge graphs and text summaries from document databases. In numerous embodiments, the application for generating knowledge graphs and text summaries from document databases can direct the processor to generate knowledge graphs and text summaries from document databases.

While specific devices for generating knowledge graphs and text summaries from document databases are described above, any of a variety of different configurations of devices for generating knowledge graphs and text summaries from document databases can be utilized as appropriate to the requirements of specific applications in accordance with various embodiments of the invention. A process for generating knowledge graphs and text summaries from document databases is discussed below.

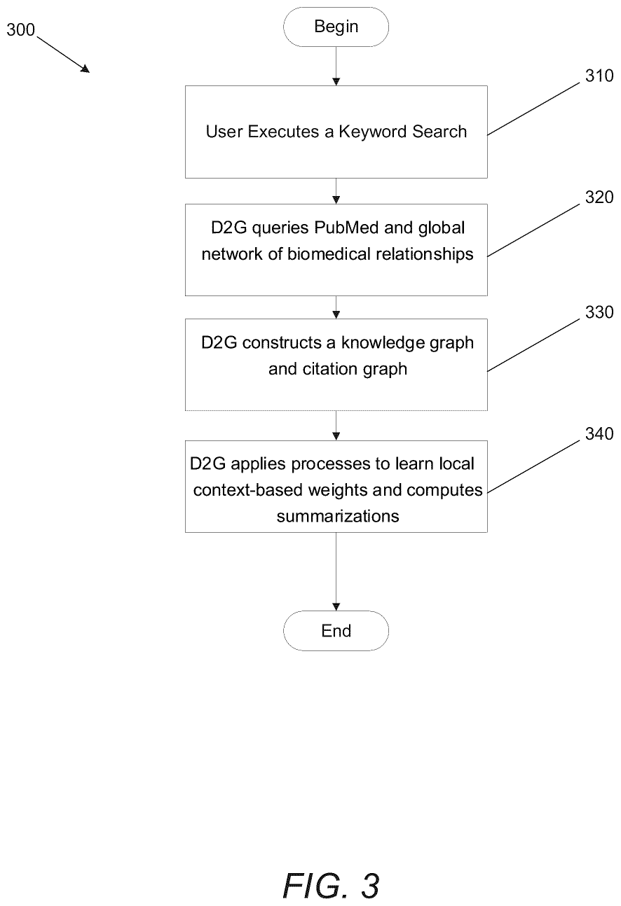

Turning now to FIG. 3, a process for generating knowledge graphs and text summaries from document databases in accordance with an embodiment of the invention is illustrated. Process 300 can include executing (310) a keyword search by the user. Process 300 can further include querying (320) global network of biomedical relationships. Process 300 can construct (330) a knowledge graph and a citation graph. Process 300 can apply (340) processes to learn local context-based weights and can compute summarizations. While specific processes for generating knowledge graphs and text summaries from document databases are described above, any of a variety of processes for generating knowledge graphs and text summaries from document databases can be utilized as appropriate to the requirements of specific applications in accordance with various embodiments of the invention. Methods for generating local knowledge graphs in accordance with various embodiments of the invention are discussed below.

### Methods for Generating Local Knowledge Graphs

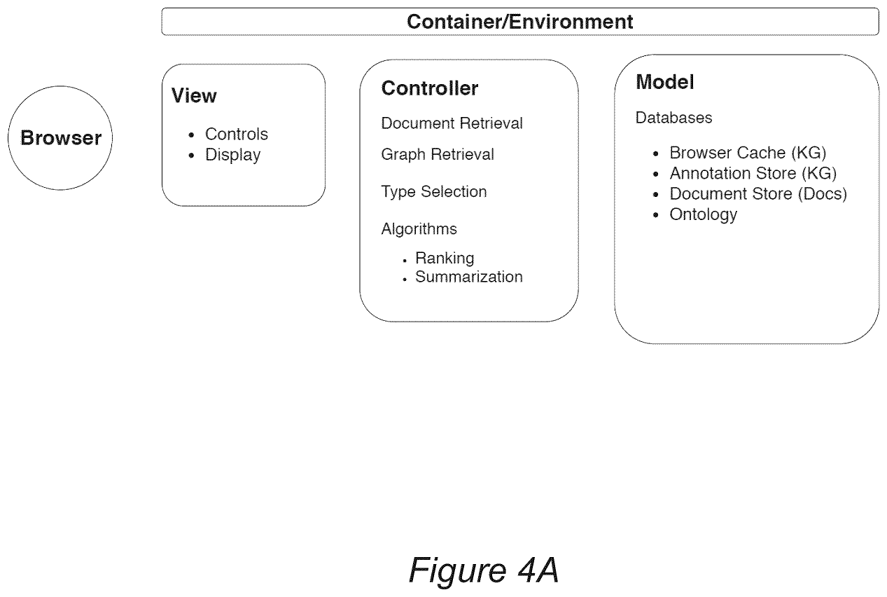

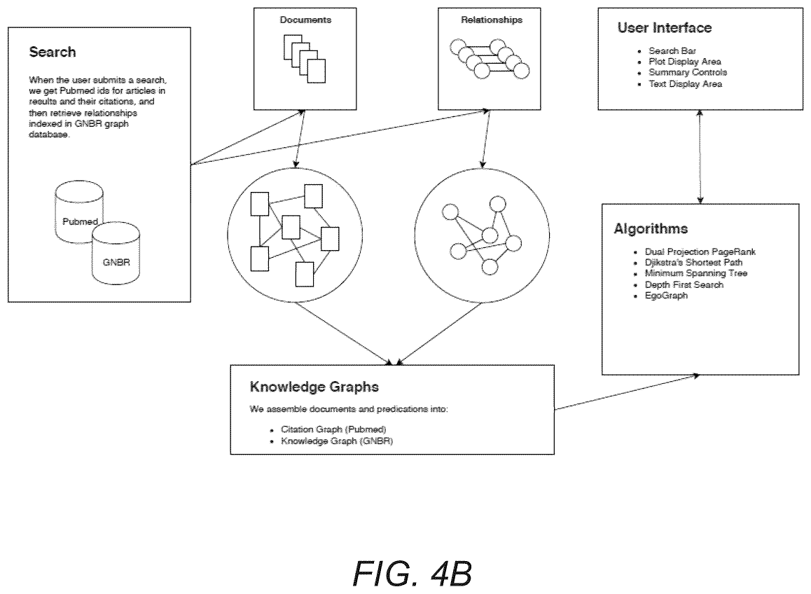

In a variety of embodiments, systems and methods for generating knowledge graphs and text summaries from document databases can implement docs2graph application using a model, a view, and a controller architecture in accordance with an embodiment of the invention as illustrated in FIGS. 4A and 4B. When the user enters a Pubmed (a search engine accessing primarily the Medical Literature Analysis and Retrieval System Online (Medline) database of references and abstracts on life sciences and biomedical topics) search, systems and methods for generating knowledge graphs and text summaries from document databases can take the result and retrieve annotations from GNBR, assemble them into a knowledge graph, compute concept and document weights, and cache the result. The user can then browse the knowledge graph with an interactive display and summarization algorithms. While specific methods for generating knowledge graphs and text summaries from document databases are described above, any of a variety of methods for generating knowledge graphs and text summaries from document databases can be utilized as appropriate to the requirements of specific applications in accordance with various embodiments of the invention. Data model and database for generating local knowledge graphs in accordance with various embodiments of the invention are discussed below.

### Data Model and Database

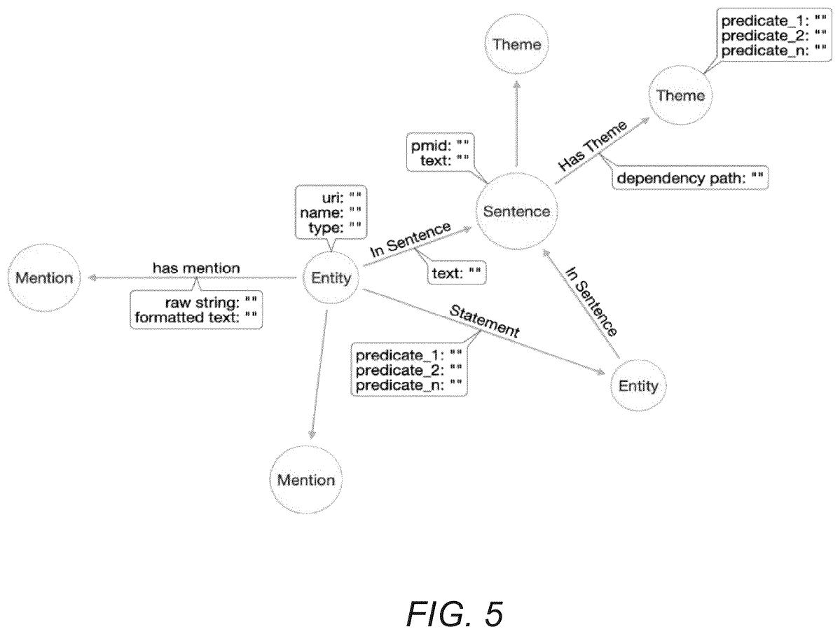

Turning now to FIG. 5, an underlying property graph data model and instantiation as neo4j graph database in accordance with an embodiment of the invention is illustrated. Note that the application can support a variety of underlying data models and formats, so long as they are graphs. In many embodiments, the underlying database does not need to be a graph database (i.e. SPRQL, or neo4j, or Janusgraph, or Redisgraph, or GraphDB, or Mongo). Any number of different structures can be used, including, but not limited to, tabular files (i.e. csv), Redis key value store, as well as standard RDB like SQL. While specific data models for generating knowledge graphs and text summaries from document databases are described above, any of a variety of different configurations of data models for generating knowledge graphs and text summaries from document databases can be utilized as appropriate to the requirements of specific applications in accordance with various embodiments of the invention. Architectures are discussed further below.

### Architecture

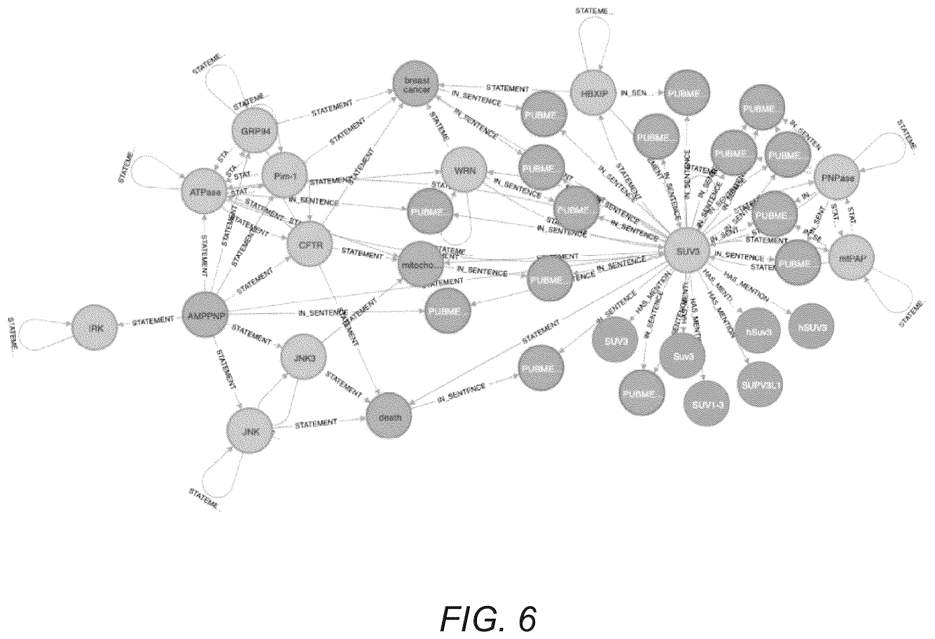

In many embodiments, systems and methods for generating knowledge graphs and text summaries from document databases can employ a standard model-view-controller (MVC) architecture. This can be implemented as either a monolithic application, or as a bundle of independent micro services as illustrated in FIG. 6 in accordance with an embodiment of the invention. In several embodiments, any of the layers may employ multiple components in parallel at each layer. For example, the application may simultaneously draw from several different document or KG stores, or several copies of the same store may be queried in parallel to enhance performance and reliability. Distributed queries can be performed using established big data methods such as Dask, Apache spark, or Hadoop. In certain embodiments, several controllers may be implemented in parallel, or several different versions of the user interface (UI) may all access the same underlying controller infrastructure. In several embodiments, single components may be replicated and placed in parallel to enhance performance and reliability. In many embodiments, a monolithic version of the application may be replicated and deployed in parallel as well. While specific architectures are described above, any of a variety of different architectures for generating knowledge graphs and text summaries from document databases can be utilized as appropriate to the requirements of specific applications in accordance with various embodiments of the invention. User interfaces are discussed further below.

### User Interface

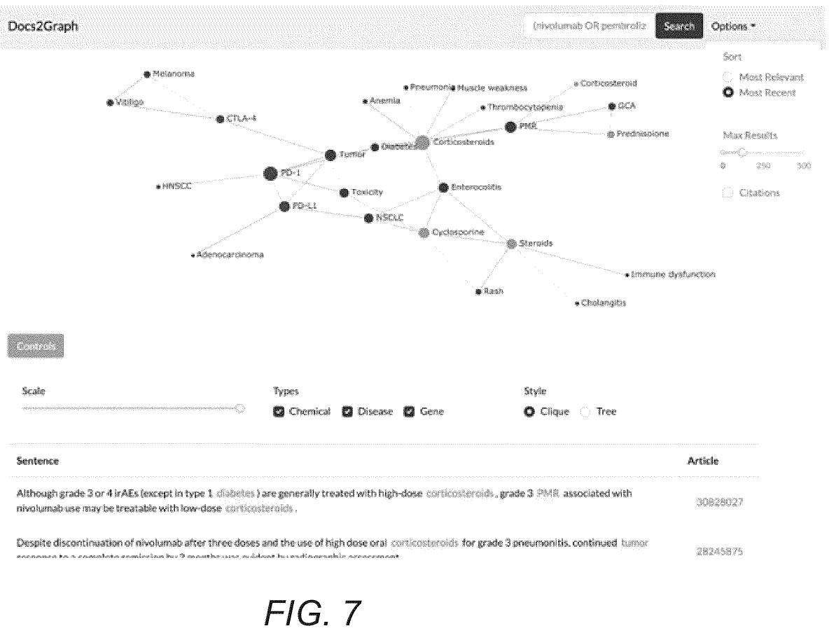

In several embodiments, the user interface (UI) can include of (a) control modules and (b) display modules. An image of a UI is shown in FIG. 7 in accordance with an embodiment of the invention. While specific user interfaces are described above, any of a variety of different user interfaces for generating knowledge graphs and text summaries from document databases can be utilized as appropriate to the requirements of specific applications in accordance with various embodiments of the invention. Control modules are discussed further below.

### Control Modules

In various embodiments, there can be two type of controls: query, or summarization. These controls may use a range of inputs such as text boxes, buttons, sliders, check boxes, or range boxes. Query controls can initiate the retrieval of a knowledge graph. This can be achieved via text entry; however, this could also be done by uploading a file containing parameters, using a drop-down bar, or series of dropdown bars. Note, the use of a free form search bar that queries a document search engine (i.e. Elastic Search on proprietary doc store, Pubmed, Bing, etc.) can be an advantageous implementation. Almost all knowledge graph browsers may require a user to specify entities and relationships via drop down menus or search fields, and the allowable input can be limited to a predefined set of entities and relationship types. This can be alien to most users, thus a freeform search bar can be much more intuitive. Summary controls can initiate and specify parameters for summarization. This can be limited to types and summary scale. In several embodiments, additional controls may be present. In certain embodiments, the (UI) may contain additional controls that allow the user to specify the terminology/ontology used, and/or the range or type of data source to draw from. While specific control modules are described above, any of a variety of different control modules for generating knowledge graphs and text summaries from document databases can be utilized as appropriate to the requirements of specific applications in accordance with various embodiments of the invention. Display modules are discussed further below.

### Display Modules

In many embodiments, there are two main display elements. (1) Graph window, and (2) Text table. 1) Graph window can display the knowledge graph. Nodes can be sized according to their weight. Edges may or may not be proportional to their weight. Hovering over nodes can bring up additional information, such as synonyms, hyperlinks to external resource, or other properties of interest. Hovering over edges can surface information about the relationship, such as amount of supporting evidence, controversy score, negation, and/or links to external resources. 2) Text table can display a text summary of the knowledge graph with accompanying citations and links to source records. Entities in the text can be highlighted as hyperlinks that may lead to external resources or trigger the launch of a new application instance. The table may also include a computationally derived paraphrasing of the evidence such as “Imatinib binds EGFR”. Note that the display modules may also have control capabilities. For example, clicking on the summary graph or table may initiate queries that transact with the controller or data store.

While specific display models for generating knowledge graphs and text summaries from document databases are described above, any of a variety of different configurations of display models for generating knowledge graphs and text summaries from document databases can be utilized as appropriate to the requirements of specific applications in accordance with various embodiments of the invention. A further description of docs2graph application is discussed further below.

### Docs2Graph

In several embodiments, systems and methods for generating knowledge graphs and text summaries from document databases can include docs2graph, which is a method/application for generating local knowledge graphs from subnetworks of global network of GNBR that can increase specificity with minimal loss of sensitivity. In some embodiments, docs2graph can generate local knowledge graphs that are sensitive, specific, and useful for pathway curation. Docs2graph can work as a module that augments the function of document retrieval engines by synthesizing information in corpora returned by searches and presenting the user with a powerful set of tools to browse annotations and locate documents of interest. It can feature weighting and summarization algorithms, and can have a simple user interface which can enable users to gradually move between simple summaries that give a sense of the big picture of the knowledge contained in a corpus of documents to more granular views. The extractive text summary can be key as it can enable users to quickly recognize and adjudicate some of the errors and ambiguities induced by automated annotation. While specific description of docs2graph for generating knowledge graphs and text summaries from document databases are described above, any of a variety of different configurations of docs2graph for generating knowledge graphs and text summaries from document databases can be utilized as appropriate to the requirements of specific applications in accordance with various embodiments of the invention.

Although specific systems and methods for generating knowledge graphs from text databases are discussed herein, many different systems architectures and processes can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A device for generating knowledge graphs and text summaries, comprising:
a processor; and
a memory containing a knowledge graph and text summary generating application, where the knowledge graph and text summary generating application directs the processor to:
query a global network of biomedical relationships;
construct a knowledge graph and a citation graph;
apply processes to learn local context-based weights and compute summarizations; and
provide results via a display.

2. The device of claim 1, wherein the knowledge graph and text summary generating application directs the processor to provide results via a user interface.

3. The device of claim 2, wherein the user interface comprises controls.

4. The device of claim 3, wherein the controls comprise a scale.

5. The device of claim 4, wherein the controls comprise types of search.

6. The device of claim 5, further comprising querying pubmed.

7. The device of claim 1, further comprising querying pubmed.

8. A system for generating knowledge graphs and text summaries, comprising:
a device, comprising:
a processor; and
a memory containing a knowledge graph and text summary generating application, where the knowledge graph and text summary generating application directs the processor to:
query a global network of biomedical relationships;
construct a knowledge graph and a citation graph;
apply processes to learn local context-based weights and compute summarizations; and
provide results via a display.

9. The system of claim 8, wherein the device is configured to interpret results of a chemical screen.

10. The system of claim 9, wherein the device is configured to interpret results of genetic experiments.

11. The system of claim 8, wherein the device is configured to characterize a knowledge space of a subject matter expert.

12. A method of generating knowledge graphs and text summaries, the method comprising:
querying a global network of biomedical relationships;
constructing a knowledge graph and a citation graph;
applying processes to learn local context-based weights and computing summarizations; and
providing results via a display.

13. The method of claim 12, wherein providing results via a display comprises displaying the results via a user interface.

14. The method of claim 13, wherein the user interface comprises controls.

15. The method of claim 14, wherein the controls comprise a scale.

16. The method of claim 15, wherein the controls comprise types of search.

17. The method of claim 16, further comprising querying pubmed.

18. The method of claim 11, further comprising querying pubmed.
